(19) United States
(12) Patent Application Publication
(10) Pub. No.: US 2009/0235951 A1
(43) Pub. Date: Sep. 24, 2009

(54) Environmentally Responsible Dental Floss and Packaging

(76) Inventors: W.E. LeGrande, Reading, PA (US); Ali M. Evazynajad, Langhorne, PA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/406,294

(22) Filed: Mar. 18, 2009

Related U.S. Application Data
(60) Provisional application No. 61/037,373, filed on Mar. 18, 2008.

(51) Int. Cl. A61C 15/04; B29C 49/00

(52) U.S. Cl. 132/321; 264/500

(57) ABSTRACT

A dental floss product includes a length of dental floss wound about a core and contained within a dispenser. The filled dispenser is packaged in a blister pack consisting of a paperboard back and a clear bubble attaching the dispenser to the back. The dental floss is formed of a PLA fiber, preferably Ingeo™ fiber, which may be coated with a wax such as soywax. Further, the core and dispenser is formed from an injection molded PLA polymer resin, the bubble is formed from a blow molded PLA polymer resin, and the back is formed of paper, preferably recycled. Accordingly the dental floss, its dispenser, and its package are all made from annually renewable resources and all are biodegradable in a land fill environment and thus extremely environmentally responsible.

### PRIORITY CLAIM

The benefit is hereby claimed of the filing date of U.S. provisional patent application Ser. No. 61/037,373 filed on Mar. 18, 2008, the disclosure of which is hereby incorporated fully by reference.

### INCORPORATED DISCLOSURES

The disclosures of U.S. patent application Ser. No. 11/773,073 filed on 3 Jul. 2007; 60/011,439 filed on 17 Jan. 2008; and 60/806,495 filed on 3 Jul. 2006 are also hereby incorporated fully by reference and may be referred to herein as the “Incorporated Disclosures.”

### TECHNICAL FIELD

The present invention relates generally to dental floss and to packaging for dental floss.

### BACKGROUND

The use of dental floss to facilitate oral and dental hygiene is well known. Many types of dental floss have been made available commercially. Traditionally, dental floss has been made largely from petroleum based or synthetic fluropolymers and fibers such as polytetrafluoroethylene (PTFE) or expanded polytetrafluoroethylene (ePTFE), which are not environmentally friendly or responsible. There remains a need for an improved dental floss as well as more environmentally and ecologically responsible dental floss. A further need exists for a dental floss dispenser and dental floss packaging that is at least as effective as current largely petroleum-based plastic dispensers and packaging, but that are biodegradable and made from renewable resources. It is to the provision of such a dental floss, dental floss dispenser, and dental floss packaging that the present invention is primarily directed.

### SUMMARY

In addition to dental floss made from the various fibers and combinations of fibers discussed in the Incorporated Disclosures, this disclosure describes a dental floss formed from Polylactide or Polylactic Acid based fiber (PLA fiber), such as, for example, Ingeo™ fiber, which is a natural PLA fiber available from NatureWorks LLC of Mennetonka, Minn. Ingeo™ fiber is a man-made fiber derived from 100% annually renewable resources such as corn, and not from oil, and is biodegradable. Another example of a PLA based fiber suitable for use in the fabrication of dental floss according to the invention is Mirel available from the Metabolix company of Cambridge, Mass. Mirel is a family of high performance, biobased plastics that are made from corn sugar and that are sustainable and totally biodegradable. In this disclosure, Ingeo™ will be used as the example when describing the invention. It should be understood, however, that the invention equally includes Mirel and/or Ingeo™ and/or combinations thereof. Indeed, the invention broadly includes the use of PLA plastics and fiber made from PLA to fabricate dental floss and its packaging.

This disclosure also describes packaging for dental floss that is made from biodegradable, environmentally responsible materials, such as, for example, from NatureWorks polymer resins derived from PLA and available from the NatureWorks LLC company of Minnetonka, Minn., and from paper, preferably recycled paper. More particularly, the dispenser for the dental floss as well as the internal core around which the dental floss is wound preferably is made from and injection moldable NatureWorks polymer resin while the clear blister pack preferably is made from a blow moldable NatureWorks polymer resin. The cardboard backing to which the blister pack attaches preferably is made of biodegradable paperboard, and most preferably from recycled paperboard. Only the small stainless steel blade that cuts a desired length of dental floss is made of non-biodegradable stainless steel, but this small component may be recycled. Thus, the invention includes a dental floss and packaging in which all components of the product and its packaging are environmentally friendly, made from renewable or recyclable sources, and virtually completely biodegradable.

While NatureWorks resins may be preferred, the invention also includes the use of other PLA resins instead of or in addition to or in combination with NatureWorks resins. For example Mirel P1001, P1002 and P2001 resins available from Metabolix might be used instead of NatureWorks resins or in addition to or in combination with NatureWorks resins. While the invention is described herein primarily in the context of NatureWorks resins, it will be understood that such resins should be construed throughout to include Mirel resins and, indeed, any PLA resins suitable for molding according to the invention.

NatureWorks LLC is the owner of several patents and patent applications directed to its PLA polymer resins and fibers and methods of their fabrication. These include U.S. Pat. Nos. 7,232,664; 7,141,410; and 7,015,302 and U.S. published patent application numbers 2007/0187876; 2007/0148748; and 2007/0092956. These patents and patent applications are hereby incorporated fully by reference as background information regarding the nature and properties of these products.

Metabolix is the owner of a substantial portfolio of patents and patent applications directed to its Mirel PLA plastics and their production and these patents are incorporated herein by reference as background information regarding the nature and properties of these products.

### DETAILED DESCRIPTION

The present invention is, in part, a dental floss or dental tape (collectively “floss”) formed at least partially from a PLA fiber, and preferably from Ingeo™ fiber and/or blends of Ingeo™ fiber with other botanic and/or non-botanic and/or natural fibers. Ingeo™ fiber is a man-made fiber derived from 100% annually renewable resources, particularly corn, and not from petroleum. It combines the qualities of natural and synthetic fibers such that strength and resilience are balanced with comfort, softness, and drape when used in textile applications. Although originally conceived for use in fabrics, fiberfill, and other textile applications, applicants have discovered that the properties of Ingeo™ fiber are particularly suitable for use in the manufacture of dental floss as an alternative to PTFE and other commonly used synthetic or petroleum-based fibers. According to the invention, the dental floss may be made completely of Ingeo™ fiber or the Ingeo™ fiber may be blended with other fibers such as, for instance, silk, soybean protein fiber, Sorona® fiber or any other suitable fibers in any appropriate combinations and proportions.

In the preferred embodiment, the dental floss made from Ingeo™ fiber is coated with an appropriate wax, most preferably soywax, to bind the fibers of the Ingeo™ fiber together into a monofilament suitable for use as dental floss and to prevent fraying of the Ingeo™ fibers from which the dental floss is made. Further, the soywax coating, because of its melting point and other characteristics, serves as an additional lubricant aiding the dental floss to slip between a user's teeth. In addition, the soywax coating helps a user hold the ends of a length of dental floss between or wrapped around the fingers without slippage because it reduces the slipperiness of the raw fiber. Soywax also is biodegradable and renewable.

Thus, the dental floss may have any suitable Ingeo™ fiber content, blended if desired with other fibers or combinations of fibers, or coated with coatings, as needed for a particular application. More particularly, the Ingeo™ fiber content may be greater than 0 wt % up to 100 wt %. In any particular embodiment, the floss may have a Ingeo™ fiber content of greater than 0 wt % to about 10 wt %, from about 10 wt % to about 20 wt %, from about 20 wt % to about 30 wt %, from about 30 wt % to about 40 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, or from about 90 wt % to 100 wt %. Numerous other ranges are contemplated by the invention.

Likewise, where other fibers are used in a blend of fibers, such other fibers may be present in any suitable amount. Thus, in a particular embodiment, each other type of fiber in a blend, independently or in combination, may be present in an amount of from greater than 0 wt % to about 10 wt %, from about 10 wt % to about 20 wt %, from about 20 wt % to about 30 wt %, from about 30 wt % to about 40 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, or from about 90 wt % to 100 wt %.

In any particular application where dental floss is blended with other fibers TM and/or coated with coatings, the dental floss may have a weight ratio of Ingeo™ fiber to any other component or combination of components of about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:20; about 2:1, about 2:3, about 2:5, about 2:7, about 2:9, about 2:11, about 2:13, about 2:15, about 3:1, about 3:2, about 3:4, about 3:5, about 3:7, about 3:8, about 3:10, about 3:11, about 3:13, about 3:14, about 4:1, about 4:3, about 4:5, about 4:7, about 4:9, about 4:11, about 4:13, about 4:15, about 5:1, about 5:2, about 5:3, about 5:4, about 5:6, about 5:7, about 5:8, about 5:9, about 5:11, about 5:12, about 5:13, about 5:14, about 6:1, about 6:5, about 6:7, about 6:11, about 6:13, about 6:14, about 6:15, about 7:1, about 7:2, about 7:3, about 7:4, about 7:5, about 7:6, about 7:8, about 7:9, about 7:10, about 7:11, about 7:12, about 7:13, about 7:15, about 8:1, about 8:3, about 8:5, about 8:7, about 8:9, about 8:11, about 8:13, about 8:15, about 9:1, about 9:2, about 9:4, about 9:5, about 9:7, about 9:8, about 9:10, about 9:11, about 9:13, about 9:14, about 10:1, about 10:3, about 10:7, about 10:9, about 10:11, about 10:13, or any other suitable ratio.

Where dental floss is made of a blend of Ingeo™ fiber and another fiber or fibers according to the invention, the other fiber or fibers may comprise any suitable fiber including, for example, silk, naturally derived or synthesized polymers or polymeric materials (e.g. other PLA based polymers), natural fibers such as cotton or wool, flax, bamboo, synthetic fibers, soy fiber, or any combination thereof, in any proportion.

The dental floss of the present invention may be formed from Ingeo™ fiber in any suitable manner, for example, from one or more fibers, one or more filaments, or any combination thereof, that are twisted, knitted, entangled, braided, woven, non-woven, or otherwise processed to form a unitary monofilament strand suitable for use as dental floss. Each individual fiber or filament used to form the dental floss may be formed from a single constituent (“monoconstituent”) or may be formed from a blend or other arrangement of multiple constituents (“multiconstituent”). Likewise, the dental floss formed from the individual fibers and/or filaments may be monoconstituent or multiconstituent. Thus, the invention contemplates a dental floss formed from any combination or blend of monoconstituent fibers, monoconstituent filaments, multiconstituent fibers, and multiconstituent filaments.

If desired, various additives may be used to impart, flavor, anti-static properties, lubricity, hydrophilicity, or any other property to the individual fibers or filaments. Such additives may be used in an amount of from about 0.1 wt % to about 20 wt %, for example, from about 5 wt % to about 10 wt %, of the fiber or filament. Likewise, a functional or aesthetic coating may be applied to and/or overlie at least a portion of the floss. Examples of such coatings that may be suitable include, but are not limited to, surfactants, fluoridating treatments, medicinal agents, antimicrobial agents, flavorings, coatings that alter the coefficient of friction of the floss, for example, wax, combinations including wax, waxes derived from vegetables or waxes derived from fruits (legumes) such as, for instance, soywax, or any other coating or treatment, as needed or desired.

The coating or treatment may be applied to the individual fibers, filaments, floss, or blended floss using any suitable technique, method, or process. Examples of processes that may be used include, but are not limited to, gravure printing, roll coating, brush treating, spraying, dipping, coating with wire wound rods, or any combination thereof. Alternatively, the treatment may be incorporated into the fiber or filament as an additive, for example, within any polymeric fibers, such that the additive diffuses to the surface thereof to form the coating.

The thread length for the dental floss is determined by the amount of thread that can be wound on the selected bobbin or core. However, other types of dental floss can be used, such as coreless dental floss, where no bobbin is required. The wound dental floss then is packed into a dispensing container. Any suitable container may be used, including various shapes, styles, and colors; however, a preferred container according to the invention is described below.

As mentioned, dental floss made from Ingeo™ fiber as described above is environmentally friendly, made entirely from annually renewable resources, and, unlike dental floss made from PTFE, ePTFE or other synthetic fibers, is biodegradable. While this is good, traditional containers, dispensers, and packaging for dental floss have generally still been made of petroleum derived or synthetic polymers and plastics, which are not biodegradable, contribute to the depletion of fossil fuel reserves, and contribute to a growing landfill problem in the United States.

The present invention includes, in addition to the dental floss itself, a dispenser and package for dental floss that addresses the problems and shortcomings of traditional dispensers and packaging. In one embodiment, dental floss made of Ingeo™ fiber is wound around a core or spool using known techniques and the core is disposed in a flip-top dispenser. The dispenser has a small feed hole through which the dental floss protrudes and a small stainless steel cutter or blade is provided to cut a desired length of dental floss pulled from the feed hole. The filled dispenser generally is packaged in a “blister pack” comprising a paperboard backing and a clear plastic bubble that encloses and attaches the dispenser to the backing. According to the present invention, the core and the dispenser housing are molded from an injection moldable PLA polymer resin, and most preferably from a NatureWorks resin such as NatureWorks 3001D or 3051D PLA polymer resin. These resins offer good optics, strength, and durability and produce a dispenser housing with an easy printing surface, which can be pigmented for a unique look. Further, dispenser housings and cores molded from such resin are environmentally responsible in that the resins are derived from corn, a renewable resource, and the containers and cores are naturally biodegradable in a landfill.

In addition, the bubble that encloses the filled dispenser in the product package is made, according to this invention, from a blow moldable PLA polymer resin, and most preferably a NatureWorks resin such as NatureWorks 7000D or 7032D polymer resins. Such bubbles, like the dispensers, cores, and dental floss, are environmentally responsible and biodegradable. Finally, the paperboard back to which the dental floss dispenser is attached with the bubble is made from paper, a biodegradable and renewable resource. However, to reduce the environmental impact of using virgin paper, the backing preferably is made of recycled paperboard.

The small stainless steel blade mounted to the dispenser that allows a user to cut a desired length of dental floss pulled from the dispenser is, obviously, not made from a renewable resource and is not biodegradable. Nevertheless, this small piece of metal can be recycled by environmentally conscious individuals if desired. In any event, such a small piece of metal is not particularly detrimental to a land fill and does not cause or leach harmful chemicals that can contaminate the water supply.

It thus will be seen that an improved dental floss product is now provided in which virtually the entirety of the product, its dispenser, and the packaging in which it is marketed is made from annually renewable resources and is biodegradable in landfills once discarded. Further, the dental floss itself has been found to perform on par with or better than dental flosses made of synthetic polymers such as PTFE or ePTFE. Various, additions, deletions, and modifications to the embodiments presented above may well be envisioned and implemented by those of skill in the art, all without departing from the spirit and scope of the invention as set forth in the claims.

What is claimed is:

1. A method of fabricating a dental floss product comprising the steps of:
(a) forming a length of dental floss at least partially from PLA fiber;
(b) winding the dental floss into a roll;
(c) forming a dispenser by molding a material comprising a PLA polymer resin;
(d) disposing the dental floss roll in the dispenser;
(e) forming a backing from paper;
(f) forming a bubble by molding a material comprising a blow moldable PLA polymer resin; and
(g) securing the bubble to the backing with the dispenser containing the dental floss roll enclosed within the bubble.

2. The method of claim 1 and wherein step (e) further comprises forming the backing from recycled paper.

3. The method of claim 1 and further comprising the step of forming a core by molding a material comprising a PLA polymer resin and wherein step (b) comprises winding the dental floss onto the core.

4. The method of claim 1 and wherein step (f) comprises blow-molding the material.

5. The method of claim 1 and where in step (a) the PLA fiber is at least partially a NatureWorks fiber.

6. The method of claim 5 and wherein the NatureWorks fiber is Ingeo™ fiber.

7. The method of claim 1 and where in step (a) the PLA fiber is at least partially Mirel™ fiber.

8. The method of claim 1 and where in step (c) the PLA polymer resin is selected from a group consisting essentially of a NatureWorks polymer resin, NatureWorks 3001D PLA polymer resing, and NatureWorks 3051D PLA polymer resin.

9. The method of claim 1 and where in step (f) the PLA polymer resin is selected from a group consisting essentially of a NatureWorks polymer resin, Natureworks 7000D polymer resin, and NatureWorks 7032D polymer resin.

10. A dental floss product comprising:
a length of dental floss formed at least partially of Ingeo™ fiber;
a core around which the dental floss is wound, the core being molded of an injection moldable NatureWorks PLA polymer resin;
a dispenser containing the wound length of dental floss, the dispenser being molded from an injection moldable NatureWorks PLA polymer resin;
a blister package for the dispenser, the blister package comprising a paperboard back and a bubble securing the dispenser to the paperboard back, the bubble being formed of a blow moldable NatureWorks PLA polymer resin.

11. The dental floss product of claim 10 and wherein the paperboard back is formed at least partially from recycled paperboard.

12. A dental floss product comprising:
a length of dental floss fabricated at least partially of PLA fiber, the length of dental floss being wound into a roll;
a dispenser containing the wound dental floss, the dispenser being molded at least partially from a PLA polymer resin;
a blister package containing the dispenser and would dental floss, the blister package comprising a paperboard back and a bubble formed at least partially from a blow moldable PLA polymer resin.

13. The dental floss product of claim 12 and wherein the PLA fiber is selected from the group consisting essentially of a NatureWorks PLA fiber, Ingeo™ PLA fiber, and Mirel PLA fiber.

14. A dental floss product comprising:
a length of dental floss formed at least partially of Mirel fiber;
a core around which the dental floss is wound, the core being molded of an injection moldable Mirel PLA polymer resin;
a dispenser containing the wound length of dental floss, the dispenser being molded from an injection moldable Mirel PLA polymer resin;
a blister package for the dispenser, the blister package comprising a paperboard back and a bubble securing the dispenser to the paperboard back, the bubble being formed of a blow moldable Mirel PLA polymer resin.
